(19) United States
(12) Patent Application Publication
(10) Pub. No.: US 2011/0052905 A1
(43) Pub. Date: Mar. 3, 2011

(54) PROCESS OF PROVIDING PRESS PLATES WITH A FLOURO-POLYMER IMPREGNATED HARD COATING

(76) Inventor: Patrick Smith, Raleigh, NC (US)

(21) Appl. No.: 12/551,091

(22) Filed: Aug. 31, 2009

(51) Int. Cl. B32B 5/16; B32B 37/02

(52) U.S. Cl. 428/323; 156/308.2; 156/306.6; 156/309.3

(57) ABSTRACT

A process of producing laminate articles comprising coating or plating the press surfaces, whether plates, or interleaved press plates, with a flouro-polymer impregnated hard coating. Typical coatings that can be used with the flouro-polymer including nickel and chrome, their combinations, and alloys thereof. Advantages of the invention are expected to include better plate life, fewer plate cleanings, fast press times while supporting lower product cost and better equipment utilization. In addition, laminate products include a flouro-polymer as part of the laminate product. The process permits the omission of the so called “overlay” layer, typically an α-cellulose layer, which overlies hard particles in the upper surface of the laminate while providing increased pressing surface life.

### BACKGROUND OF THE INVENTION

(1) Field of the Invention

This invention is directed to novel laminates and processes for producing the same by use of a pressing apparatus. The laminates of the present invention have an abrasion resistant surface created by including a plurality of small hard particles, at least some of which are adjacent to the pressing apparatus during fabrication of the laminate. Pressing apparatus used to form such laminates may be a laminate press having press plates, a press belt, or a plurality of a laminate layers may separated by press plates such that a stack of laminate products may be pressed and formed during a single press cycle. The pressing apparatus applies pressure to form and consolidate the individual layers or laminae into a laminate article. Abrading or polishing of the pressing surfaces, whether of the press plates, or the interleaved press plates is caused by the presence of the small hard particles. Reduction of scratching is accomplished by use of a flouro-polymer incorporated into a coating on the pressing surface. The novel laminated article also comprises the same flouro-polymer.

(2) Description of Related Art

Laminate articles produced by pressing are generally well known and have been widely distributed over the last several decades. Laminate articles are usually composed of a plurality of layers or laminae with are consolidated under heat and pressure in a pressing apparatus. The layers may be separately impregnated with a binding agent, such as a thermosetting resin, or may alternatively be previously impregnated, dried and partially cured to the so-called B-stage to form a “prepreg” which is then fed into a press with one or more other layers of paper, or core materials, such as fiberboard (usually medium density fiberboard (MDF) or high density fiberboard (HDF)), flax, gypsum, plywood, particleboard, oriented strandboard (OSB), recycled thermosetting and/or thermoplastic materials, virgin thermosetting particles secured together with a binder, synthetic or natural rubber containing layers, and mixtures thereof; and a backing or “balance” layer to prevent warping of the laminate. The backing layer is also usually formed of a thermosetting resin with one or more paper layers and is conventionally in the form of a prepreg. Suitable thermosetting resins include melamine-formaldehyde, phenol-formaldehyde, phenol-urea-formaldehyde and polyester resins. The upper surface of the laminate may include one or more decorative layers, such as a printed or monochromatic décor paper, or the aforementioned “core” may itself be decorated, such as by printing a decorative ink directly thereon, by applying paint or lacquer layers in different patterns thereon, or by combinations of the same.

However, the upper surfaces of such laminates heretofore produced were capable of being scratched, or otherwise marred unless a plurality of hard particles were applied to the surface.

In commonly assigned U.S. Pat. No. 4,940,503 there is disclosed a process for the production of a decorative thermosetting laminate with an abrasion resistant surface layer in which a plurality of hard particles were applied during the manufacturing process. This process produced the first abrasion resistant laminates which were capable of being utilized in high abrasion areas, such as floor boards, thereby producing flooring which is resistant to impact, such as caused by women's high heel shoes, as well as scratches, caused by grit and other debris adhering to the under surface of shoes or the movement of furniture legs across the surface. Hard particles having a Moh's hardness of at least 5, preferably at least 6, such as aluminum oxide, silica, silicon nitride, silicon carbide, diamond and other similar hard particles have been found useful to impart abrasion resistance to such laminate articles. An uppermost “overlay” layer of α-cellulose impregnated with a resin, such as a thermosetting resin, e.g., a melamine-formaldehyde resin, was placed over the abrasive particles.

However, in commonly assigned U.S. Pat. No. 6,106,654 (hereby incorporated by reference in its entirety), it was reported that when producing such wear resistant and scratch resistant surface layers in laminate articles even when using the overlay layer, the press plates used during the laminating process were often scratched by relatively big particles in the surface of the laminate. As such press plates are very expensive and manufactured from high quality materials, intermediate layers of disposable aluminum foil had been used to protect the press plates, which affected the production cost.

The patentees of U.S. Pat. No. 6,106,654 thereby proposed applying the hard particles into different coatings, the upper coating of which had particles of not larger than 15 μm and the other side of the paper web, or on a separate paper containing such hard particles, had particles having an average particle size of 30-90 μm. This process reduced the scratching of the press plates by providing the smallest particles directly upwards towards the pressing surface and the larger particles away from the press plate. However, as abrasion resistant laminates became increasingly popular, especially for floors, higher standards of abrasion resistance were promulgated, thereby requiring more flexibility in the size and loading of abrasion resistant particles, than could be achieved by the aforementioned process.

Thus, there still exists a need for preventing scratching of the pressing surface during the production of laminate particles containing a plurality of small hard particles.

It is also possible to create a number of laminate articles in a single pressing cycle by stacking a number of layers of laminate forming layers on metal press plates and then loading the stack into the laminate press. Upon activation, the press plates impart pressure to the entire stack and the press plates distribute this pressure onto the stack, thereby creating multiple laminates in a single press cycle. Such a process is shown in U.S. Pat. No. 3,215,579 (hereby incorporated by reference in its entirety).

Each of these prior art patents are herein incorporated by reference in their entirety.

### BRIEF SUMMARY OF THE INVENTION

The present invention is directed to providing a process for producing laminate products including thermosetting resins. The pressing surface used in the process may either take the form of press plates, which are directly attached or adjacent to the press, or a press plate which is provided in a stack of interleaved laminate materials so as to simultaneously press a plurality of laminates at the same time.

Most preferably such press plates/press plates/belts are formed of a metal, such as stainless steel with a coating of nickel and/or chrome or alloys thereof which can be impregnated with a flouro-polymer.

New laminate particles containing a flouro-polymer as a component thereof are also disclosed herein, having an abrasion resistant surface produced by a plurality of hard particles in the laminate product. Such materials can be used for floor, wall and ceiling panels, building boards, and components of floors providing an abrasion resistant surface to provide many years of acceptable life without surface scratches.

### A BRIEF DESCRIPTION OF THE DRAWINGS

FIG. 1 is a schematic view of a laminating press; and

FIG. 2 is a schematic view of a multiplate press.

### DETAILED DESCRIPTION OF THE PREFERRED EMBODIMENTS

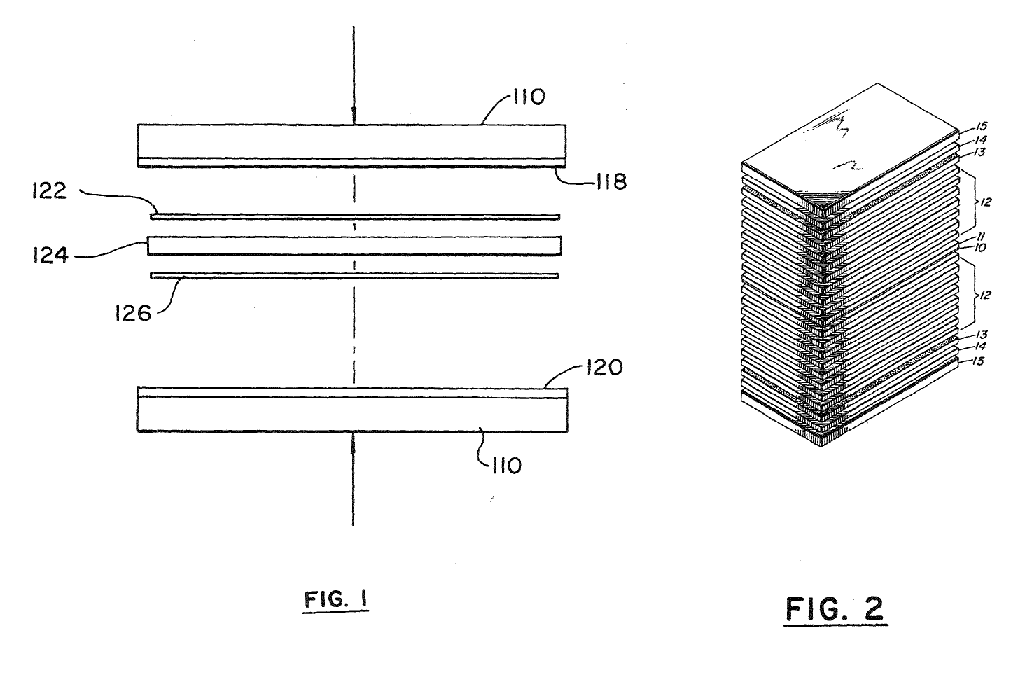

As heretofore noted, the production of laminates, especially thermosetting decorative laminates is generally well known. Thus, laminates may be produced utilizing a laminating press of the type as shown in FIG. 1 having an upper and lower plates 110, respectively, operated by hydraulic, pneumatic, mechanical, electrical, or other forces (not shown) to create pressure when the plates 110 are moved relative to each other. The most preferred form of press is a hydraulically operated press, where the lower plate 110 is fixed and only upper plate 110 is moveable. However, other forms of presses can be used. In use a plurality of laminae are inserted between plates 110 and consolidated into an article or laminate. The laminae can consist of one or more layers themselves, at least to some of which a thermosetting resin has been applied, with or without previous curing into the so called B-stage and being consolidated in the press under elevated temperature and elevated pressure.

FIG. 1 is typical of a pressing apparatus into which is fed a plurality of laminae, at least one being a decorative paper or décor layer 122 comprising one or more layers, being a wood veneer (typically having a thickness of 0.2-2.0 mm), a printed or monochromatic paper layer, optionally impregnated with a thermosetting resin and at least one base layer paper or core material 124. As suitable base layers are Kraft or other paper layers impregnated with a thermosetting resin and as suitable core materials are various cellulosic layers such as MDF or HDF, plywood, oriented strandboard, particleboard, gypsum, flax; gypsum, thermosetting and/or thermoplastic particles bound together with an adhesive, recycled thermosetting resin particles, etc. The thermosetting resin can be either coated as a liquid which is then dried; optionally cured into a B-stage; or freshly applied resin which is still wet. An upper layer of the laminae would include hard particles having a Moh's hardness of at least about 5, most preferably at least about 6, and comprises particles of, for example, aluminum oxide, silicia, silicon carbide, silicon nitride, diamond, and combinations thereof. These hard particles are preferably of small size, i.e., having an average particle size ranging from about 2 to about 120 microns, more preferably about 5 to about 90 microns, most preferably about 8 to about 80 microns. Thus, as used herein, “small hard” particles have an average particle size up to 120 microns and Moh's hardness of at least about 5. These small hard particles are typically dispersed across the upper layer, for example, sprinkled on the surface or imbedded throughout the paper or resin. It would be evident that without the protection afforded by the invention, the hard particles in proximity to the press plates 110 can be in a position to scratch or mar the surface of the plates thereby decreasing the plate life, as well as producing minor defects or gouges in the surface of the plate, thereby resulting in subsequently produced laminate having the negative reproduction or change in gloss of these surface defects in its upper surface. Other laminae could include sound dampening layers of natural of synthetic foamed or unfoamed rubber, balance layers, on acoustic layer or the bottom of the laminate.

Of recent interest in the field of laminates, especially those used for floors, is the production of laminates which are “realistic” in the sense of duplicating natural materials. For example, if a wood floor is to be replaced by a laminate it would be desirable that the laminate appear to include surface structuring of real wood, such as knot holes, graining, pits, micro-cracks and other similar surface features, as are found in real wood floors. These surface features could, for example, enhance or be “in register” with the image below, or may be random. The same is true for other types of simulated natural products, such as stone or mineral floors reproduced by laminates which have raised and/or depressed surfaces. Thus, the surfaces of plates 110 are, most often, covered with a metal such as nickel and/or chrome metals or their alloys. Plate 110 and/or the coating 118 on upper plate 110 might have the negative surface of wood board, such as small protrusions to simulate pits or graining in the laminate. Coating 120 on lower plate 110 would not necessarily need the same degree of surface decoration, as it normally is making a bottom side of the laminate product, not normally seen in use. However, there may be surface features stippling or other structural surface features also present on the bottom of the laminate imparted by lower plate 110 coating 120 on lower plate 110.

In order to avoid the scratching of the upper plate 110 and extension of the plate life, the present invention coats the plate 110, typically formed of stainless steel, with a nickel and/or chrome coating 118. In the present invention the metal coating will be impregnated with a flouro-polymer, such as a fluoro-carbon, CF₃ (CF₂)n-CF₃, such as a polytetrafluoroethylene polymer having a weight average molecular weight of 400,000-9,000,000; such materials are commercially available under the “TEFLON” brand. Applicants believe that the present invention can provide a pressing surface that not only has a much better release from the laminate surface including those surfaces containing protrusions and depressions, but also that the press plate can be utilized in more pressing cycles without the need to repair or replace the plate surface.

Even though most conventional laminates have at least one so called “overlay” layer, such as α-cellulose as a top layer over the hard particles, the present invention also makes it possible to omit this “overlay” layer and have the wear resistant hard particles applied directly to the top surface of uppermost laminae without any overlay paper. Such a process produces a product which is much more desirable because the presence of the overlay can obscure, even if in a minor degree, the decor on the décor layer. It is also considered within the scope of the invention to incorporate at least some of the abrasion resistant particles into an uppermost surface or layer of the core material itself.

Turning again to FIG. 1 there is shown a press in which upper and lower press plates 110 are provided with a nickel and/or chrome coating 118, 120 respectively, which coatings 118, 120 are impregnated with a flouro-polymer such as polytetrafluoroethylene. An impregnated décor layer 122, comprising a décor paper having hard particles, applied directly thereon while the thermosetting resin is still wet, is laminated to a core 124 formed of prepreg Kraft paper layers and balance layer 126 by closing press plates 110 thereby applying elevated pressure while under elevated heat conditions to bond layers 122, 124 and 126 into a laminate. Although, in this embodiment layers 124 and 126 are prepreg paper core and balance layers, they may readily be substituted by other materials such as the core materials, previously described such as MDF, HDF, and/or particleboard, gypsum, plywood, OSB, flaxboard, etc. Décor paper 122 may be impregnated with a thermosetting resin which has been dried or even partially cured to the so-called B-stage or may still be wet. As an example only, layer 124 may be a prepreg of the so called B-stage cure resin impregnated paper, or other core materials as described. Adhesive (not shown) may inserted between any of layers 122, 124 and 126, especially when such layers are of the partially B-stage cured type. The resulting laminate products are highly abrasion resistant and may be utilized in high wear areas such as floor board, planks, tiles, etc. When so utilized the edges of the laminate may be provided with joining elements, such as grooves and/or tenons or may be employed with separate joining pieces to join individual boards into a unitary floor structure. Laminate floors are, most typically, not attached to any substructure, such as a subfloor, but are called “floating floors” as they are free to move independently of the substructure. Thus, the joining elements therefore lock the individual laminate boards together, not only to prevent separation in the vertical direction, but also horizontally along the edge of the joint between boards. This can be achieved by any of the known locking systems in the art said as that found in U.S. Pat. No. 5,706,621 and its reissue, US RE 39,439; U.S. Pat. Nos. 6,006,486; 6,101,778; and 6,397,547; all incorporated herein by reference.

When utilizing a press plate with a flouro-polymer impregnated coating, such provides not only a much better release from the pressing plate during the lamination process but also reduced scratching of the pressing surface adjacent the hard particles. With low-pressure or direct pressure lamination this means that there is lower probability of sticking of resin to, or on, the press plate which will allow faster press times and potentially lower production costs. During pressing, as described above, the plate is typically heated before it is pressed against the various layers. Do to the interaction between the plate and the layers as a result of the pressure and temperature, there is most often, adhesion. This adhesion will, typically, be a bottleneck of the pressing procedure. By incorporating the materials of the invention, its believed that the adhesion will be substantially reduced or eliminated completely. It is anticipated that production speeds may be increased greater than 10%.

It is also considered within the scope of the invention to include a blower (not shown) to apply an air stream between the pressed laminate and the press plate after pressing to further reduce any adhesion. This air should be heated to a temperature close to the temperature of the plates and/or heated laminate to reduce the risk of uneven cooling.

Furthermore, the expected better plate life (more press cycles before refinishing), potentially fewer plate cleanings and faster press times, all are expected to support lower product cost and better equipment utilization.

A distinct advantage of the invention is realized when the “true liquid overlay” products are produced, where the wear resistant particles are applied directly to the top of the décor without any overlay paper. As discussed, U.S. Pat. Nos. 4,940,503 and 6,106,654 used overly papers as a layer over the abrasive particles and the press surface, but as reported in U.S. Pat. No. 6,106,654, scratching of the press plates was still experienced. The present process would permit omission of the overlay sheet, yet still be expected to extend press plate life due to reduced scratching.

Prior to the invention, plate life in producing products without any overlay was unacceptably low (approximately only 10% or less of plate life as compared to producing traditional products with overlays) resulting in high plate costs and investments (additional plates to ensure capacity and high refurbishing costs). Thus, the present invention is expected to not only avoid the use of the traditional “overlay” layer of α-cellulose, resulting in diminished material, costs while simultaneously increasing the plate life significantly over the plate experience without using the current invention.

FIG. 2 is similar to the pressing cycle of FIG. 1 except therein a press plates 11 (of which there could be any number) is provided between various layers, forming the laminate such as overlay sheet 14, décor sheet 13 having a covering of small hard particles, core layer 12 such that a plurality of separate laminate products can be produced in a single pressing cycle. However, in each case the press plate 11, (similar to upper and lower press plates 15) can also be provided on at least one side with a metal or metallic alloy coating 10, such as a nickel or chrome coating which has been impregnated with the flouro-polymer according to the present invention, to achieve the advantage achieved with the single product production cycle discussed in FIG. 1.

### Example 1

A roll of overlay paper of α-cellouse with a surface weight of 40 g/m² can be impregnated with a solution of melamine-formaldehyde resin to a resin content of 70% by weight calculated on dry impregnated paper. The impregnated paper can be fed continuously into a heating oven where the solvent can be evaporated. At the same time the resin can be partially cured to a so called B-stage. Usually such a product that can be obtained will be called prepreg.

A roll of décor paper i.e., a paper that can have print to form a surface decoration, with a surface weight of 80 g/m² can be treated in the same way as the overlay paper. The resin content can be 40% by weight calculated on dry impregnated paper.

A roll of décor paper with a surface weight of 170 g/m² can also be treated in the same way, with the exception that a resin comprising phenol-formaldehyde resin, instead of melamine-formaldehyde resin, can be used. The resin content can be 30% calculated on dry impregnated paper. Three of the above prepreg sheets can be impregnated with phenol-formaldehyde resin (to create a core paper), one décor paper and an overlay paper can be placed between two press plates which can be treated according to the present invention. The sheets can be pressed at a pressure of 90 kp/cm² at a temperature of 145° C. to form a homogenous decorative laminate. The press plates are expected to exhibit no adhesion of the thermosetting resin upon opening. Analysis of the resulting laminate is expected to show that some of the fluoro-polymer which could be have been impregnated into the coating on the press plates would migrate into the laminate.

### Example 2

A process similar to Example 1 can be practiced except that the overlay paper of α-cellulose can be omitted and the hard particles can be placed directly on a wet resin décor paper before the press cycle so as to be in contact with a press plate which could be treated according to the present invention. A laminate article is expected to show migration of the fluoro-polymer into the laminate products and improved lubricity of press plates which can be treated according to the invention are expected to permit an extended use of the press plates before cleaning and/or refurbishing.

Although having described my invention in connection with specific embodiments thereof, it should be understood that such embodiments are only exemplary and not limiting and that various modifications to the invention may be made without departing from the spirit and scope of the invention.

1. A process for reducing the wear of press plates during production of a laminate containing a plurality of small hard particles comprising:
(a) providing at least two layers; wherein at least one of the layers is a décor;
(b) providing a plurality of small hard particles on or over the décor to impart an abrasion resistance over the décor;
(c) placing the at least two layers, including the décor between plates of a press; wherein at least one of the plates comprises a coating of a metal impregnated with a fluoro-polymer, wherein the small hard particles are positioned in proximity to said at least one plate with the coating; and
(d) applying a positive pressure and heating to consolidate the at least two layers, including the décor and the hard particles to form the laminate.

2. The process of claim 1, further providing an overlay sheet of α-cellulose over the hard particles such that the coating contacts the overlay sheet during step (d).

3. The process of claim 1, further comprising providing each of the plates with a coating of metal impregnated with a fluoropolymer.

4. The process of claim 1, wherein the metal is one selected from the group consisting of nickel, chrome, combinations thereof and alloys thereof.

5. The process of claim 1, wherein the fluoropolymer is polytetrafluoroethylene.

6. The process of claim 1, wherein the particles are at least one selected from the group consisting of silica, silicon carbide, silicon nitride and diamond.

7. The process of claim 1, wherein at least one of the plates is provided with at least one of protrusions and depressions to impart surface structure to the surface of the laminate, and the coating covers the at least one of protrusions and depressions.

8. The process of claim 1, wherein the décor is provided directly on a core.

9. The process of claim 1, wherein the décor comprises a printed or monochromatic paper sheet impregnated with a thermosetting resin.

10. The process of claim 9, wherein the décor layer comprises small hard particles.

11. The process of claim 8, wherein the core is at least one selected from the group consisting of a plurality of paper sheets, fiberboard, plywood, particleboard, oriented strand board, flax, gypsum, thermosetting particles adhered together with a binder, and natural wood.

12. The process of claim 1, wherein a plurality of components (a), (b), and (c) are stacked in layers in the press, providing a press plate between each stack, providing said press plates on at least one side with a coating of a metal impregnated with a fluoro-polymer and applying elevated pressure and elevated temperature to consolidate each of the stacks into separate laminates.

13. The process of claim 12, wherein both sides of the press plates are provided with the coating of metal impregnated with a fluoro-polymer.

14. The process of claim 12, further comprising providing the coating with at least one of protrusions and depressions to impart surface structure to the surface of the laminate.

15. A laminate article comprising:
at least one decorative surface;
a plurality of small hard particles on or in the decorative surface; and
a fluoro-polymer.

16. The laminate article of claim 15, wherein the decorative surface is a part of a separate layer of the laminate.

17. The laminate of claim 15, wherein the decorative surface is at least one selected from the group consisting of paper, thermosetting laminate and wood veneer.

18. The laminate article of claim 17, further comprising a core, to which the decorative surface is adhered.

19. The laminate article of claim 17, further comprising an overlay sheet of α-cellulose over the hard particles.

20. The laminate article of claim 18, wherein the core comprises at least one material selected from the group consisting of a plurality of paper sheets, fiberboard, plywood, particle board, oriented strand board, flax, gypsum, thermosetting particles adhered with a binder and natural wood.
